(19) United States
(12) Patent Application Publication
(10) Pub. No.: US 2015/0187486 A1
(43) Pub. Date: Jul. 2, 2015

(54) MULTILAYER ELECTRONIC COMPONENT AND MANUFACTURING METHOD THEREOF

(71) Applicant: SAMSUNG ELECTRO-MECHANICS CO., LTD., Suwon-Si (KR)

(72) Inventor: Bong Sup LIM, Suwon-si (KR)

(73) Assignee: SAMSUNG ELECTRO-MECHANICS CO., LTD., Suwon-Si (KR)

(21) Appl. No.: 14/221,066

(22) Filed: Mar. 20, 2014

(30) Foreign Application Priority Data
Jan. 2, 2014 (KR) 10-2014-0000286

(51) Int. Cl. H01F 27/29; H01F 27/32; H01F 41/04; H01F 27/28

(52) U.S. Cl. CPC H01F 27/29; H01F 27/2804; H01F 27/323; H01F 41/041; H01F 2027/2809

(57) ABSTRACT

A multilayer electronic component in which when an internal coil is formed in a direction perpendicular with respect to a substrate mounting surface and external electrodes are only formed on one surface (a lower surface) of the chip element facing a substrate at the time of mounting the chip element, the one surface to which the internal coil is exposed and on which the external electrodes need to be formed may be easily distinguished, and a manufacturing method thereof.

### CROSS-REFERENCE TO RELATED APPLICATION

This application claims the benefit of Korean Patent Application No. 10-2014-0000286 filed on Jan. 2, 2014, with the Korean Intellectual Property Office, the disclosure of which is incorporated herein by reference.

### BACKGROUND

The present disclosure relates to a multilayer electronic component and a manufacturing method thereof.

An inductor, which is one of electronic components, is a representative passive element forming an electronic circuit together with a resistor and a capacitor to remove noise. Such an inductor may be combined with the capacitor using electromagnetic characteristics to configure a resonance circuit amplifying a signal in a specific frequency band, a filter circuit, or the like.

In the case of a multilayer inductor, inductance may be implemented by forming a coil pattern using a conductive paste, or the like, on insulator sheets mainly formed of a magnetic material and stacking the sheets to form a coil in a sintered multilayer body.

A vertical multilayer inductor in which an internal coil is disposed in a direction perpendicular with respect to a substrate mounting surface in order to implement high inductance has been known. The vertical multilayer inductor may have high inductance as compared to a multilayer inductor in which an internal coil is disposed in a horizontal direction with respect to a substrate mounting surface and may allow for an increase in a self resonant frequency.

Meanwhile, external electrodes for connecting the internal coil to an external circuit may be formed on the multilayer inductor. When the external electrodes are formed on both end surfaces of a sintered multilayer body in a length direction and portions of surfaces adjacent to the end surfaces by performing a dipping method using a conductive paste, or the like, thicknesses of the external electrodes may be increased and there is a limitation in miniaturizing a chip element.

Particularly, in a case in which the external electrodes are formed on both end surfaces in the length direction, in the vertical multilayer inductor, so as to be parallel with the internal coil, an eddy current may be generated in the external electrodes, causing an increase in loss due to the generation of the eddy current, and stray capacitance may be generated between the internal coil and the external electrode. Such stray capacitance may lead to a decrease in the self resonant frequency of the inductor.

Therefore, in the vertical multilayer inductor, an attempt at forming the external electrode on one surface (a lower surface) of the chip element facing a substrate at the time of mounting the chip element to thereby allow for miniaturization of the chip element and suppress the loss due to the generation of the eddy current has been conducted.

However, in the case of forming external electrodes on both end surfaces of a multilayer body in a length direction according to the related art, since shapes of the both end surfaces in the length direction are different from those of the remaining four surfaces, the surfaces on which the external electrodes will be formed may be easily distinguished. However the four surfaces except for the both end surfaces of the multilayer body in the length direction have the same shape as each other, it may be difficult to distinguish a surface to which an internal coil is exposed, among the four same surfaces.

### SUMMARY

An exemplary embodiment in the present disclosure may provide a multilayer electronic component capable of forming external electrodes only on one surface (a lower surface) of a chip element facing a substrate at the time of mounting the chip element by forming an internal coil in a direction perpendicular with respect to a substrate mounting surface and distinguishing the one surface to which the internal coil is exposed, and a manufacturing method thereof.

According to an exemplary embodiment in the present disclosure, a multilayer electronic component may include: a multilayer body formed by stacking a plurality of insulating layers; an internal coil part including internal coil patterns formed on the insulating layers and electrically connected to one another through vias and first and second lead portions exposed to the same surface of the multilayer body, disposed to be perpendicular with respect to the stacked layers of the multilayer; and first and second external electrodes formed on the same surface of the multilayer body disposed to be perpendicular with respect to the stacked layers of the multilayer body, and connected to the first and second lead portions of the internal coil part, respectively, wherein a marking pattern is formed on one surface of the multilayer body, disposed parallel to the stacked layers of the multilayer body.

The marking pattern may be only formed in an area equal to or smaller than half of an overall area of the one surface of the multilayer body disposed parallel to the stacked layers of the multilayer body.

The marking pattern may be formed on an upper or lower portion of the one surface of the multilayer body disposed parallel to the stacked layers of the multilayer body, in a length direction.

The marking pattern may be formed on a left or right portion of the one surface of the multilayer body disposed parallel to the stacked layers of the multilayer body, in a thickness direction.

The surface of the multilayer body, to which the first and second lead portions of the internal coil part are exposed, may be distinguished by the marking pattern.

The internal coil part may be formed in a direction perpendicular with respect to a substrate mounting surface of the multilayer body.

According to an exemplary embodiment in the present disclosure, a multilayer electronic component may include: a multilayer body formed by stacking a plurality of insulating layers; an internal coil part including internal coil patterns formed on the insulating layers and electrically connected to one another through vias and first and second lead portions exposed to the same surface of the multilayer body, disposed to be perpendicular with respect to the stacked layers of the multilayer; and first and second external electrodes formed on the same surface of the multilayer body disposed to be perpendicular with respect to the stacked layers of the multilayer body, and connected to the first and second lead portions of the internal coil part, respectively, wherein a marking pattern is only formed on a portion of one surface of the multilayer body, disposed parallel to the stacked layers of the multilayer body, such that the surface of the multilayer body, to which the first and second lead portions of the internal coil part are exposed, is distinguished by the marking pattern.

The marking pattern may be formed along a length direction on an upper or lower portion of the one surface of the multilayer body disposed parallel to the stacked layers of the multilayer body, in an area smaller than or equal to half of an overall area of the one surface of the multilayer body.

The marking pattern may be formed along a thickness direction on a left or right portion of the one surface of the multilayer body disposed parallel to the stacked layers of the multilayer body, in an area equal to or smaller than half of an overall area of the one surface of the multilayer body.

According to an exemplary embodiment the present disclosure, a manufacturing method of a multilayer electronic component may include: preparing a plurality of insulating sheets; forming internal coil patterns on the insulating sheets; stacking the insulating sheets including the internal coil patterns formed thereon to form a multilayer body including an internal coil part having first and second lead portions exposed to the same surface of the multilayer body, disposed to be perpendicular with respect to the stacked sheets; forming a marking pattern on one surface of the multilayer body, disposed parallel to the stacked sheets of the multilayer body; and forming first and second external electrodes connected to the first and second lead portions of the internal coil part, respectively, on the same surface of the multilayer body, disposed to be perpendicular with respect to the stacked sheets of the multilayer body.

The marking pattern may be only formed in an area equal to or smaller than half of an overall area of the one surface of the multilayer body disposed parallel to the stacked sheets of the multilayer body.

The marking pattern may be formed on an upper or lower portion of the one surface of the multilayer body, disposed parallel to the stacked sheets of the multilayer body, in a length direction.

The marking pattern may be formed on a left or right portion of the one surface of the multilayer body, disposed parallel to the stacked sheets of the multilayer body, in a thickness direction.

An insulating sheet on which the marking pattern is formed, among the plurality of insulating sheets, may be stacked on an outermost portion of the multilayer body.

In the forming of the first and second external electrodes, the surface of the multilayer body, to which the first and second lead portions of the internal coil part are exposed and on which the first and second external electrodes need to be formed, may be distinguished by the marking pattern.

The insulating sheets may be stacked in a direction perpendicular with respect to a substrate mounting surface of the multilayer body.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic perspective view of a multilayer electronic component according to an exemplary embodiment in the present disclosure, in which an internal coil part is shown;

FIG. 2 is an exploded perspective view of the multilayer electronic component according to an exemplary embodiment in the present disclosure;

FIG. 3 is a schematic perspective view of the multilayer electronic component according to an exemplary embodiment in the present disclosure before an external electrode is formed;

FIGS. 4A through 4E are views showing both surfaces S_{w1} and S_{w2} of the multilayer electronic component according to the exemplary embodiment of the present disclosure in a width direction and both surfaces S_{T} and S_{B} thereof in a thickness direction before an external electrode is formed;

FIG. 5 is a perspective view of a multilayer electronic component according to an exemplary embodiment in the present disclosure;

FIG. 6 is a perspective view of another example of the multilayer electronic component according to an exemplary embodiment in the present disclosure; and

FIG. 7 is a process view showing a manufacturing method of a multilayer electronic component according to an exemplary embodiment in the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Multilayer Electronic Component

Hereinafter, a multilayer electronic component according to an exemplary embodiment of the present disclosure will be described. Particularly, a multilayer inductor will be described, but the present disclosure is not limited thereto.

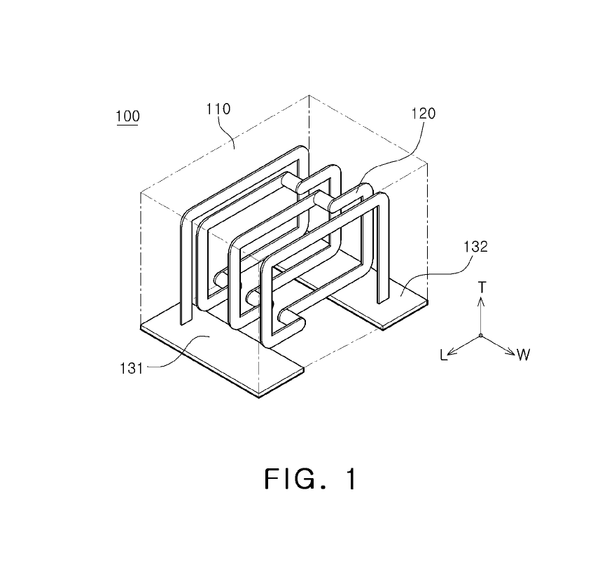

FIG. 1 is a schematic perspective view showing a multilayer electronic component according to an exemplary embodiment of the present disclosure, in which an internal coil part is shown.

Referring to FIG. 1, a multilayer electronic component 100 according to an exemplary embodiment of the present disclosure may include a multilayer body 110; an internal coil part 120, and first and second external electrodes 131 and 132.

The multilayer body 110 may be formed by stacking a plurality of insulating layers 111, and the plurality of the insulating layers 111 may be in a sintered state and may be integrated such that a boundary between adjacent dielectric layers may not be readily apparent, without using a scanning electron microscope (SEM).

The multilayer body 110 may have a hexahedral shape, and a direction of a hexahedron will be defined in order to clearly describe the exemplary embodiments of the present disclosure. L, W and T shown in FIG. 1 refer to a length direction, a width direction, and a thickness direction of the hexahedron, respectively.

The multilayer body 110 may include a ferrite material commonly known in the art such as Mn—Zn based ferrite, Ni—Zn based ferrite, Ni—Zn—Cu based ferrite, Mn—Mg based ferrite, Ba-based ferrite, Li-based ferrite, or the like.

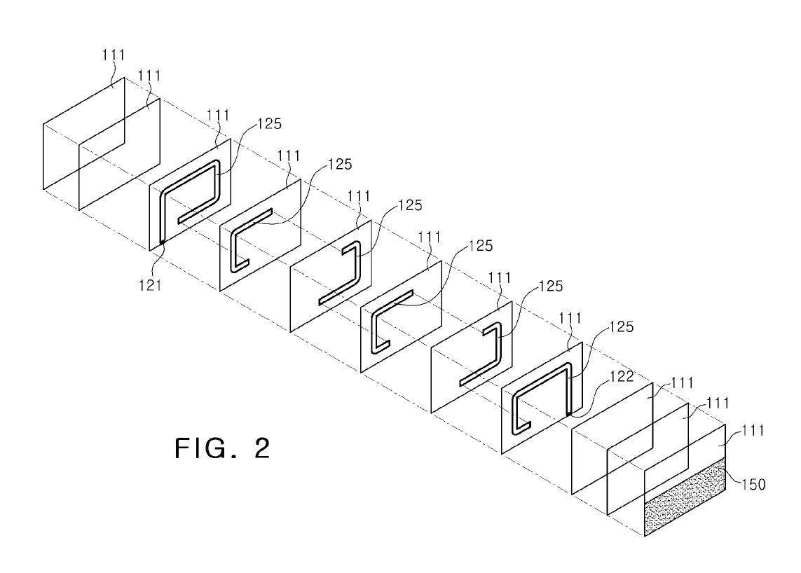

FIG. 2 is an exploded perspective view of the multilayer electronic component according to the exemplary embodiment of the present disclosure.

Referring to FIG. 2, the internal coil part 120 may include internal coil patterns 125 formed by printing a conductive paste containing a conductive metal on the plurality of insulating layers 111 forming the multilayer body 110 at a predetermined thickness.

The conductive metal for forming the internal coil patterns 125 is not particularly limited as long as the metal has excellent electrical conductivity. For example, as the conductive metal, silver (Ag), palladium (Pd), aluminum (Al), nickel (Ni), titanium (Ti), gold (Au), copper (Cu), platinum (Pt), or the like, may be used alone, or a mixture thereof may be used.

Vias may be formed in predetermined positions of the respective insulating layers 111 on which the internal coil patterns 125 are printed, and the internal coil patterns 125 formed on the respective insulating layers 111 may be connected to one another through the vias to thereby form a single coil.

In this case, as the plurality of insulating layers 111 on which the internal coil patterns 125 are formed are stacked in the width direction (W) or the length direction (L), the internal coil part 120 may be formed in a direction perpendicular with respect to a substrate mounting surface of the multilayer body 110.

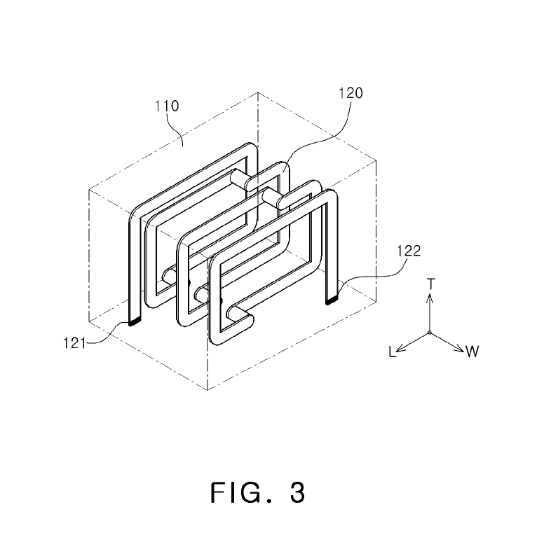

FIG. 3 is a schematic perspective view of the multilayer electronic component according to the exemplary embodiment of the present disclosure before an external electrode is formed.

Referring to FIG. 3, first and second lead portions 121 and 122 of the internal coil part 120 may be exposed to the same surface of multilayer body 110, disposed to be perpendicular to the stacked layers of multilayer body 110. For example, the first and second lead portions 121 and 122 may be exposed to one end surface of the multilayer body 110 in the thickness (T) direction, disposed to be perpendicular to the stacked insulating layers 111.

The first and second external electrodes 131 and 132 may be formed on the same surface perpendicular with respect to the stacked layers of the multilayer body 110 in such a manner that the first and second external electrodes 131 and 132 may be connected to the first and second lead portions 121 and 122 of the internal coil part 120, respectively.

In this case, in order to distinguish the surface to which the first and second lead portions 121 and 122 are exposed and on which the first and second external electrodes 131 and 132 need to be formed, a marking pattern 150 may be formed on one surface of the multilayer body 110.

The marking pattern 150 may be formed one surface of the multilayer body 110 disposed parallel to the stacked layers of the multilayer body 110.

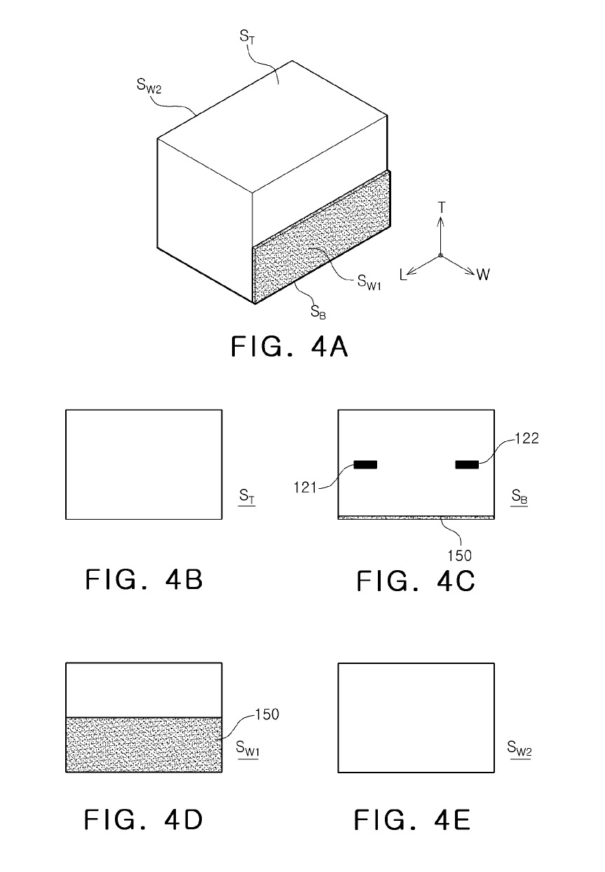

FIGS. 4A through 4E are views showing both surfaces S_{w1} and S_{w2} of the multilayer electronic component according to the exemplary embodiment of the present disclosure in the width direction and both surfaces S_{T} and S_{B} thereof in the thickness direction before an external electrode is formed.

Referring to FIGS. 4A through 4E, the marking pattern 150 is formed on one surface of the multilayer body 110 disposed parallel to the stacked layers of the multilayer body 110, both surfaces S_{w1} and S_{w2} of the multilayer body 110 in the width direction and both surfaces S_{T} and S_{B} of the multilayer body 110 in the thickness direction may have different shapes from each other.

Therefore, the surface on which the first and second external electrodes 131 and 132 need to be formed may be easily distinguished, and the multilayer body 110 may be arranged in a direction for the application of the first and second external electrodes 131 and 132.

The marking pattern 150 may be only formed in an area equal to or smaller than half of an overall area of one surface of the multilayer body 110 disposed parallel to the stacked layers of the multilayer body 110.

The marking pattern 150 is only formed in an area equal to or smaller than the half of the overall area of the one surface, rather than being formed on the entirety of the one surface disposed parallel to the stacked layers of the multilayer body 110, such that the both surfaces S_{w1} and S_{w2} in the width direction and the both surfaces S_{T} and S_{B} in the thickness direction may have different shapes, and all of the four surfaces may be distinguished by the marking pattern 150. Therefore, the multilayer body 110 may be arranged in a direction for the application of the first and second external electrodes 131 and 132 by distinguishing the surface to which the first and second lead portions 121 and 122 of the internal coil part 120 are exposed.

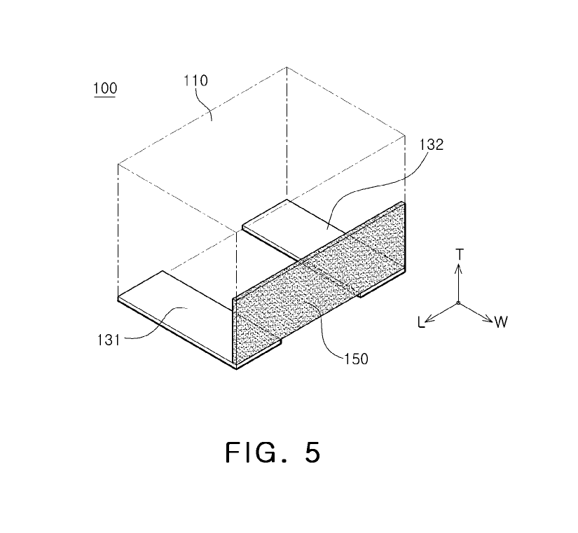

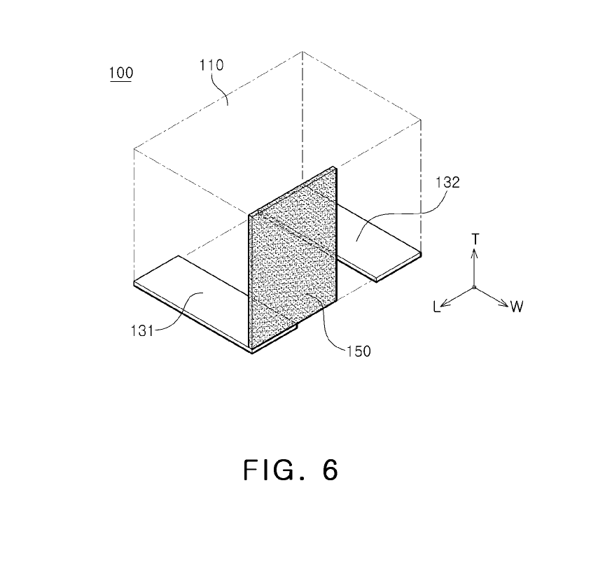

FIGS. 5 and 6 are perspective views each illustrating a multilayer electronic component according to another exemplary embodiment of the present disclosure.

Referring to FIG. 5, the marking pattern 150 may be formed on an upper or lower portion of one surface of the multilayer body 110 disposed parallel to the stacked layers of the multilayer body 110, in the length direction.

Referring to FIG. 6, the marking pattern 150 may be formed on a left or right portion of one surface of the multilayer body 110 disposed parallel to the stacked layers of the multilayer body 110, in the thickness direction.

A shape of the marking pattern 150 is not limited to shapes shown in FIGS. 5 and 6. That is, the shape of the marking pattern 150 is not particularly limited as long as the marking pattern 150 may be formed on one surface of the multilayer body 110 disposed parallel to the stacked layers of the multilayer body 110, such that the surface of the multilayer body 110 to which the first and second lead portions 121 and 122 of the internal coil part 120 are exposed may be distinguished.

Manufacturing Method of Multilayer Electronic Component

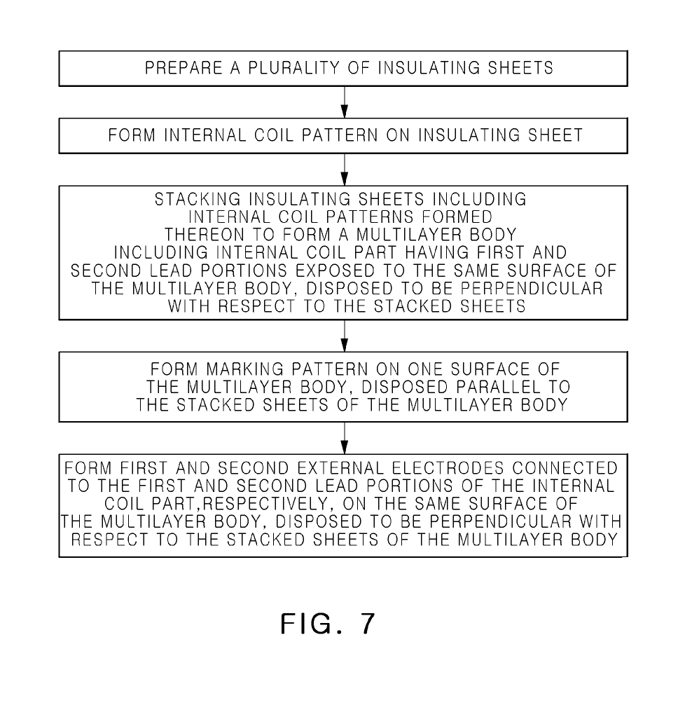

FIG. 7 is a process view showing a manufacturing method of a multilayer electronic component according to an exemplary embodiment of the present disclosure.

Referring to FIG. 7, first, a plurality of insulating sheets 111 may be prepared.

A magnetic material used to manufacture the insulating sheets 111 is not particularly limited. For example, ferrite powder known in the art such as Mn—Zn based ferrite powder, Ni—Zn based ferrite powder, Ni—Zn—Cu based ferrite powder, Mn—Mg based ferrite powder, Ba based ferrite powder, Li based ferrite powder, or the like, may be used.

The plurality of insulating sheets 111 may be prepared by applying a slurry formed by mixing the magnetic material and an organic material to carrier films and drying the same.

Next, the internal coil patterns 125 may be formed on the insulating sheets 111.

The internal coil patterns 125 may be formed by applying a conductive paste containing a conductive metal onto the insulating sheets 111 using a printing method, or the like. As the printing method of the conductive paste, a screen printing method, a gravure printing method, or the like, may be used, but the present disclosure is not limited thereto.

The conductive metal is not particularly limited as long as the metal has excellent electrical conductivity. For example, as the conductive metal, silver (Ag), palladium (Pd), aluminum (Al), nickel (Ni), titanium (Ti), gold (Au), copper (Cu), platinum (Pt), or the like, may be used alone, or a mixture thereof may be used.

Then, the insulating sheets 111 on which the internal coil patterns 125 are formed may be stacked, thereby forming the multilayer body 110 including the internal coil part 120 having the first and second lead portions 121 and 122 exposed to the same surface of the multilayer body 110, disposed to be perpendicular to the stacked layers.

Vias may be formed in predetermined positions in the respective insulating layers 111 on which the internal coil patterns are printed, and the internal coil patterns 125 formed on the respective insulating layers 111 may be connected to one another through the vias to thereby form a single coil.

The first and second lead portions 121 and 122 of the internal coil part 120 formed of a single coil may be exposed to the same surface of multilayer body 110, disposed to be perpendicular to the stacked layers of multilayer body 110.

Meanwhile, the plurality of insulating layers 111 on which the internal coil patterns 125 are formed are stacked in the width (W) or length (L) direction, the internal coil part 120 may be formed in a direction perpendicular to a substrate mounting surface of the multilayer body 110.

In this case, the marking pattern 150 may be formed on one surface of the multilayer body 110 disposed parallel to the stacked layers of the multilayer body 110.

The marking pattern 150 may be printed on the insulating sheet 111, and the insulating sheet 111 on which the marking pattern 150 is formed may be stacked on an outermost portion of the multilayer body 110.

The marking pattern 150 may be only formed in an area equal to or smaller than half of the overall area of one surface of the multilayer body 110 disposed parallel to the stacked layers of the multilayer body 110.

The marking pattern 150 may be only formed in the area equal to or smaller than half of the overall area of the one surface, rather than being formed on the entirety of the one surface disposed parallel to the stacked layers of the multilayer body 110, such that the both surfaces S_{w1} and S_{w2} in the width direction and the both surfaces S_{T} and S_{B} in the thickness direction may have different shapes, and all of the four surfaces may be distinguished by the marking pattern 150. Therefore, the multilayer body 110 may be arranged in a direction for the application of the first and second external electrodes 131 and 132, by distinguishing the surface to which the first and second lead portions 121 and 122 of the internal coil part 120 are exposed.

The marking pattern 150 may be formed on an upper or lower portion of one surface of the multilayer body 110 disposed parallel to the stacked layers of the multilayer body 110, in the length direction.

In addition, the marking pattern 150 may be formed on a left or right portion of one surface of the multilayer body 110 disposed parallel to the stacked layers of the multilayer body 110, in the thickness direction.

Thereafter, the first and second external electrodes 131 and 132 connected to the first and second lead portions 121 and 122 of the internal coil part 120, respectively, may be formed on the same surface of the multilayer body 110, disposed to be perpendicular to the stacked layers of the multilayer body 110.

In this case, the surface of the multilayer body 110 to which the first and second lead portions 121 and 122 of the internal coil part 120 are exposed and on which the first and second external electrodes 131 and 132 need to be formed may be distinguished by the marking pattern 150, such that the multilayer body 110 may be arranged in a direction for the application of the first and second external electrodes 131 and 132.

The external electrodes 131 and 132 may be formed using a conductive paste containing a metal having excellent electrical conductivity, and the conductive paste may contain for example, one of nickel (Ni), copper (Cu), tin (Sn), silver (Ag), and the like, or an alloy thereof, or the like.

Other features overlapped with those of the above-mentioned multilayer electronic component according to the exemplary embodiment of the present disclosure will be omitted.

As set forth above, according to exemplary embodiments of the present disclosure, in a case in which an internal coil is formed in a direction perpendicular with respect to a substrate mounting surface and external electrodes are only formed on one surface (a lower surface) of the chip element facing a substrate at the time of mounting the chip element, the one surface to which the internal coil is exposed and on which the external electrodes need to be formed may be easily distinguished.

While exemplary embodiments have been shown and described above, it will be apparent to those skilled in the art that modifications and variations could be made without departing from the spirit and scope of the present disclosure as defined by the appended claims.

What is claimed is:

1. A multilayer electronic component comprising:
a multilayer body including a plurality of insulating layers stacked in a stacking direction;
an internal coil part including internal coil patterns disposed on the insulating layers and electrically connected to one another through vias, and first and second lead portions exposed to a same surface of the multilayer body, the same surface being perpendicular to the stacked layers of the multilayer body;
first and second external electrodes disposed on the same surface of the multilayer body disposed to be perpendicular to the stacked layers of the multilayer body, and connected to the first and second lead portions of the internal coil part, respectively; and
a marking pattern disposed on a surface of the multilayer body, the surface being parallel to the stacked layers of the multilayer body.

2. The multilayer electronic component of claim 1, wherein the marking pattern is only formed in an area equal to or smaller than half of an overall area of the one surface of the multilayer body disposed parallel to the stacked layers of the multilayer body.

3. The multilayer electronic component of claim 1, wherein the marking pattern is formed on an upper or lower portion of the one surface of the multilayer body disposed parallel to the stacked layers of the multilayer body, in a length direction.

4. The multilayer electronic component of claim 1, wherein the marking pattern is formed on a left or right portion of the one surface of the multilayer body disposed parallel to the stacked layers of the multilayer body, in a thickness direction.

5. The multilayer electronic component of claim 1, wherein the surface of the multilayer body, to which the first and second lead portions of the internal coil part are exposed, is distinguished by the marking pattern.

6. The multilayer electronic component of claim 1, wherein the internal coil part is formed in a direction perpendicular with respect to a substrate mounting surface of the multilayer body.

7. A multilayer electronic component comprising:
a multilayer body including a plurality of insulating layers stacked in a stacking direction;
an internal coil part including internal coil patterns disposed on the insulating layers and electrically connected to one another through vias, and first and second lead portions exposed to a same surface of the multilayer body, the same surface being perpendicular to the stacked layers of the multilayer body;
first and second external electrodes disposed on the same surface of the multilayer body disposed to be perpendicular to the stacked layers of the multilayer body, and connected to the first and second lead portions of the internal coil part, respectively; and
a marking pattern disposed on only a portion of a surface of the multilayer body, the surface being parallel to the stacked layers of the multilayer body, such that the surface of the multilayer body, to which the first and second lead portions of the internal coil part are exposed, is distinguished by the marking pattern.

8. The multilayer electronic component of claim 7, wherein the marking pattern is formed along a length direction on an upper or lower portion of the one surface of the multilayer body disposed parallel to the stacked layers of the multilayer body, in an area equal to or smaller than half of an overall area of the one surface of the multilayer body.

9. The multilayer electronic component of claim 7, wherein the marking pattern is formed along a thickness direction on a left or right portion of the one surface of the multilayer body disposed parallel to the stacked layers of the multilayer body, in an area equal to or smaller than half of an overall area of the one surface of the multilayer body.

10. A manufacturing method of a multilayer electronic component, the manufacturing method comprising:
preparing a plurality of insulating sheets;
forming internal coil patterns on the insulating sheets;
stacking the insulating sheets including the internal coil patterns formed thereon to form a multilayer body including an internal coil part having first and second lead portions exposed to the same surface of the multilayer body, disposed to be perpendicular to the stacked sheets;
forming a marking pattern on one surface of the multilayer body, the surface being parallel to the stacked sheets of the multilayer body; and
forming first and second external electrodes connected to the first and second lead portions of the internal coil part, respectively, on the same surface of the multilayer body, disposed to be perpendicular to the stacked sheets of the multilayer body.

11. The manufacturing method of claim 10, wherein the marking pattern is only formed in an area equal to or smaller than half of an overall area of the one surface of the multilayer body disposed parallel to the stacked sheets of the multilayer body.

12. The manufacturing method of claim 10, wherein the marking pattern is formed on an upper or lower portion of the one surface of the multilayer body, disposed parallel to the stacked sheets of the multilayer body, in a length direction.

13. The manufacturing method of claim 10, wherein the marking pattern is formed on a left or right portion of the one surface of the multilayer body, disposed parallel to the stacked sheets of the multilayer body, in a thickness direction.

14. The manufacturing method of claim 10, wherein an insulating sheet on which the marking pattern is formed, among the plurality of insulating sheets, is stacked on an outermost portion of the multilayer body.

15. The manufacturing method of claim 10, wherein in the forming of the first and second external electrodes, the surface of the multilayer body, to which the first and second lead portions of the internal coil part are exposed and on which the first and second external electrodes need to be formed, is distinguished by the marking pattern.

16. The manufacturing method of claim 10, wherein the insulating sheets are stacked in a direction perpendicular with respect to a substrate mounting surface of the multilayer body.
